(19) United States
(12) Patent Application Publication
(10) Pub. No.: US 2008/0008639 A1
(43) Pub. Date: Jan. 10, 2008

(54) Catalyst for Carbon Monoxide Removal and Method of Removing Carbon Monoxide With the Catalyst

(75) Inventors: Hiroaki Sakurai, Osaka (JP); Susumu Tsubota, Ibaraki (JP); Masatake Haruta, Ibaraki (JP); Masato Kiuchi, Osaka (JP)

Correspondence Address: KUBOVCIK & KUBOVCIK, SUITE 710, 900 17TH STREET NW, WASHINGTON, DC, 20006, US

(73) Assignee: NATIONAL INSTITUTE OF ADVANCED INDUSTRIAL SCIENCE AND TECHNOOGY, Chiyoda-ku (JP)

(21) Appl. No.: 11/628,799

(22) PCT Filed: May 17, 2005
(86) PCT No.: PCT/JP05/08948

§ 371 Date: Feb. 8, 2007

(30) Foreign Application Priority Data
Jun. 8, 2004 (JP) 2004-169391

(51) Int. Cl. B01D 53/86; B01J 23/52; B01J 29/12

(52) U.S. Cl. 423/230; 204/157.3; 428/116; 428/98; 502/344; 502/60

(57) ABSTRACT

The present invention provides a method for effectively suppressing the deactivation of a gold nanoparticle catalyst by removing both carbon dioxide and water from a gas to be treated, thereby effectively removing carbon monoxide over a long period of time. The present invention relates to a catalyst for removing carbon monoxide having a carbon dioxide and water remover and a gold nanoparticle catalyst in which gold particles with an average particle diameter of 25 nm or less are supported on a metal oxide; and a method for removing carbon monoxide from a gas containing carbon monoxide, having a step of treating a gas containing carbon monoxide with the carbon dioxide and water remover and the gold nanoparticle catalyst in which gold particles with an average particle diameter of 25 nm or less are supported on a metal oxide.

### TECHNICAL FIELD

The present invention relates to a catalyst for removing carbon monoxide and a method for removing carbon monoxide from a gas containing carbon monoxide using the catalyst.

### BACKGROUND OF THE INVENTION

Carbon monoxide is commonly known as a gas produced by the incomplete combustion of organic matter. Due to its strong toxicity, carbon monoxide has serious adverse effects on the human body when it exists in the air of our living environment. Thus, there are strong demands for the development of a technique for effectively removing carbon monoxide using a room temperature catalyst or an adsorbent, etc. Carbon monoxide is generally produced from cigarette smoke, the exhaust gas of a car, and the like. In the case of incomplete combustion caused by a fire, gas leak, boiler problems, or heater problems, a large amount of high-concentration carbon monoxide spreads through the air.

A gas mask is used to remove high-concentration carbon monoxide in an emergency. The required performance of a carbon monoxide canister for use in a gas mask is prescribed in JIS (JIS T 8152 gas respirators). More specifically, the carbon monoxide concentration at the gas-mask outlet needs to maintain a level of 50 ppm or less for a given period of time (e.g., 180 minutes or more for a gas mask with chest type canister, 30 minutes for gas masks with chin type or mouthpiece type canister) under a 30-L/min flow of air containing 1% carbon monoxide.

Hopcalite (a copper-manganese based complex oxide) is known as a catalyst which satisfies these conditions, and is inserted in a carbon monoxide canister together with a moisture adsorbent. Hopcalite is a catalyst capable of oxidizing carbon monoxide into carbon dioxide at room temperature. However, hopcalite is disadvantageous in that it can be used only immediately after its container is opened because its performance sharply decreases in concentrations of about 0.2 to about 0.3% compared with a high concentration of about 1% and hopcalite activity is sharply lost due to humidity.

With the enforcement of the “Health Promotion Law” in May 2003 and other similar events, which stipulate the prevention of passive smoking and the like, as a turning point, the production of comparatively low-concentration carbon monoxide caused by smoking has posed a serious problem in recent years. As a standard for carbon monoxide concentration in indoor air, the Ordinance on Health Standards in the Office (Law on Industrial Safety and Health) has defined that the carbon monoxide concentration in, for example, an office as a working place shall be 50 ppm or less. In addition, the carbon monoxide concentration in an office equipped with an air-conditioner is stipulated to be 10 ppm or less as a standard for the cleanliness of the air supplied. In particular, as a measure against smoking at work, the “Guidelines for Measures on Smoking in the Workplace” (Ministry of Labor, February 1996) stipulates that the air condition be measured in accordance with the Ordinance on Health Standards in the Office, and necessary measures shall be taken so that the carbon monoxide concentration of the surrounding environment is 10 ppm (standard value) or less.

Although the amount of carbon monoxide produced by smoking is the largest among the harmful gas components produced by smoking, no existing air cleaners can completely remove carbon monoxide. This is because, in prior art techniques, there were no catalysts or adsorbents capable of efficiently removing carbon monoxide over a wide concentration range from low to high concentrations.

As described above, hopcalite comprising a metal oxide only is effective for treating high-concentration carbon monoxide. On the other hand, catalysts of noble metal, such as platinum, palladium, and the like, can continuously remove carbon monoxide by oxidation under heated conditions of 200° C. or more. However, when contacting with high-concentration carbon monoxide around room temperature, such noble metal catalyst(s) rapidly deactivate due to self-poisonous by strong adsorption of carbon monoxide on the surface of the noble metal(s).

In contrast, the inventors reported that catalysts in which gold nanoparticles have been supported on an oxide surface (hereinafter referred to as “gold nanoparticle catalyst”) can remove carbon monoxide by oxidation in actual air over a wide range of 10 to 10000 ppm (Non-patent document 1). It is also found that the activity of the gold nanoparticle catalyst is dramatically high in its early stage, but gradually degrades in air.

[Non-patent document 1]

Abstract of 91st Annual Meeting (A) of Catalysis Society of Japan, 1P 12 (2003), Sakurai, Tsubota, Haruta, published on March, 2003

### DISCLOSURE OF THE INVENTION

### Problem to be Solved by the Invention

The inventors further studied and found that catalyst life can be greatly improved by using an alkali porous substance in the form of a mixture with a gold nanoparticle catalyst. The inventors have filed another patent application (Japanese Unexamined Patent Application No. 2002-355792) based on this finding.

However, when the smoke in the gas phase emitted from a smoldering cigarette is brought into contact with a gold nanoparticle catalyst, the activity of the gold nanoparticle catalyst degrades more rapidly than in the air mentioned before. Therefore, it is a matter of course that a method for mixing an alkali porous substance with a gold nanoparticle catalyst is also effective for tobacco combustion gases. However, for long-term usage as an air cleaner, catalysts with a longer operating life are required.

A major reason for this is that tobacco combustion gas contains at least several thousands of various chemical compositions other than carbon monoxide, and some of them are known to poison gold catalysts even in a small amount. Examples of such compounds include sulfur-based compounds such as hydrogen sulfides and the like; acid compounds such as hydrogen cyanides and the like; chlorine-containing compounds such as chlorobenzene, and the like; etc.

The concentration of each of these poisonous substances in tobacco combustion gas is different from each other and moreover, even in the same concentration, the poisonous effects on a catalyst differ from every substance. Therefore, it is not easy to clarify any particular substance that will shorten catalyst life more substantially than other poisonous substances.

The inventors searched for a filter that would treat tobacco combustion gas beforehand to remove poisonous substances and bring the treated gas into contact with a gold nanoparticle catalyst, thereby maintaining the carbon monoxide removal performance of the catalyst over a long period of time (i.e., extending catalyst life). Although an activated carbon impregnated with an acid-gas-adsorbing alkali, which was highly effective among alkali porous substances disclosed in Japanese Unexamined Patent Application No. 2002-355792, also exhibited effects as a filter, the effects were not always sufficient. The composition of tobacco combustion gas after passing through a filter or a catalyst was analyzed to correlate the tobacco combustion gas and catalyst life, but no correlation between catalyst life and a component peculiar to tobacco combustion gas was found. However, it was unexpectedly found that the catalyst life is extended when carbon dioxide is sufficiently removed.

Carbon dioxide is surely contained in the ordinary combustion gas of an organic substance and is usually present in air in a concentration of about 300 ppm to about 500 ppm. Moreover, since carbon dioxide is a reaction product formed when carbon monoxide is removed by a gold nanoparticle catalyst, the production amount is larger when the concentration of the carbon monoxide to be removed is higher.

It has never clearly reported that the life of gold catalyst for carbon monoxide removal is shortened by only carbon dioxide. When the influence of carbon dioxide on the catalyst life was examined using a model gas prepared by adding pure carbon monoxide to an synthetic air obtained by mixing pure nitrogen with pure oxygen, it was confirmed that the catalyst life was noticeably shortened when both carbon dioxide and water were further added to the model gas.

Accordingly, a principal object of the invention is to provide a method for efficiently removing carbon monoxide over a long period of time while effectively suppressing any deactivation of the gold nanoparticle catalyst by removing both carbon dioxide and water from the gas to be treated.

### Means for Solving the Problem

The inventors of the present invention carried out extensive research in view of the above problems and found that catalyst life is greatly extended when the gas to be treated (a gas containing carbon monoxide) is treated with a carbon dioxide and moisture remover beforehand and is then brought into contact with a gold nanoparticle catalyst. It was also found that the catalyst life is notably extended when a gold nanoparticle catalyst and a carbon dioxide and moisture remover are mixed and the mixture is brought into contact with the gas to be treated. Further, it was found that zeolite is most effective for use as a filter.

The inventors carried out further research based on these findings and accomplished the present invention.

More specifically, the present invention provides the following methods for removing carbon monoxide.

Item 1. A method for removing carbon monoxide from a gas to be treated, comprising treating the gas with a carbon dioxide and water remover and a gold nanoparticle catalyst in which gold particles having an average particle diameter of 25 nm or less has been supported on a metal oxide.

Item 2. A method for removing carbon monoxide according to item 1, comprising bringing the gas into contact with the carbon dioxide and water remover and then bringing the treated gas into contact with the gold nanoparticle catalyst.

Item 3. A method for removing carbon monoxide according to item 1, comprising binging the gas into contact with a mixture of the gold nanoparticle catalyst and the carbon dioxide and water remover.

Item 4. A method for removing carbon monoxide according to any one of items 1 to 3, wherein the carbon dioxide and water remover is zeolite having a pore size of 0.4 nm or more.

Item 5. A method for removing carbon monoxide according to any one of items 1 to 4, wherein the temperature of the gold nanoparticle catalyst ranges about room temperature to about 100° C.

Item 6. A method for removing carbon monoxide according to item 5, further comprising irradiating the gold nanoparticle catalyst with light.

Item 7. A catalyst for removing carbon monoxide comprising a carbon dioxide and water remover and a gold nanoparticle catalyst in which gold particles having an average particle diameter of 25 nm or less are supported on a metal oxide.

Item 8. A catalyst for removing carbon monoxide according to item 7, wherein the carbon dioxide and water remover is zeolite having a pore size of 0.4 nm or more.

Item 9. A filter comprising the catalyst for removing carbon monoxide according to item 7 or 8.

Item 10. A filter according to item 9, having any one of a granule form, a honeycomb form, a bead form, or a fiber form.

Item 11. An air cleaner, comprising a filter according to item 10.

Item 12. A gas mask for carbon monoxide, comprising a filter according to item 10.

Hereinafter, the present invention will be described in detail.

I. Catalyst for Removing Carbon Monoxide

A catalyst for removing carbon monoxide of the invention comprises a carbon dioxide and water remover and a gold nanoparticle catalyst in which gold particles having an average particle diameter of 25 nm or less are supported on a metal oxide. The present invention encompasses any embodiments using the carbon dioxide and water remover and the gold nanoparticle catalyst in combination for removing carbon monoxide, irrespective of whether they are mixed or not.

Carbon Dioxide and Water Remover

Any carbon dioxide and water removers capable of removing carbon dioxide and water are usable without limitation in the invention. The carbon dioxide and water remover used in the invention refers to the single use of a compound or composition having the ability to remove both carbon dioxide and water or the combined use of a compound or composition having the ability to remove carbon dioxide and a compound or composition having the ability to remove water. Carbon dioxide and water may be removed by a cooling method, a method using a physical adsorbent, a chemical removal method, and the like.

According to the cooling method, a material is packed in a column and cooled at about −80° C., and the result is used as the carbon dioxide and water remover. By passing a gas to be treated therethrough, carbon dioxide and water in the gas are condensed at low temperatures, and removed. As a packing material, for example, glass bead, glass wool, quartz sand, and the like are usable without limitation. Such a packing material may be used in such a manner as not to block the column. The removal efficiency can be further increased using at least one of the physical-adsorbents described later as the packing material.

The method using a physical adsorbent utilizes a physical-adsorption phenomenon in which water and carbon dioxide are adsorbed onto a porous substance with a large surface area. In general, an adsorbent capable of adsorbing a large amount of carbon dioxide also has the ability to adsorb a large amount of water. There is no limitation to the apparent form (macro structure) of such an adsorbent, and, for example, a powder-like form, fiber-like form, sponge-like form, honeycomb-like form, etc., can be mentioned. More specifically, zeolite, pillared clay, molecular sieving carbon, activated carbon, carbon black, silica, mesoporous silica, alumina, iron oxide, titanium oxide, and the like or a mixture thereof can be mentioned. These substances can be used at room temperature without cooling. Among the above, zeolite, which is an inorganic adsorbent with a micropore structure, is most preferable as an adsorbent because zeolite has the ability to adsorb a large amount of carbon dioxide and water in a wide concentration range and also has a high adsorption rate.

The pore diameter of zeolite varies depending on the crystal structure and the exchangeable ions, and the molecular size that zeolite can adsorb differs in every zeolite type. For example, the pore diameter of A-type zeolite can be varied by changing the type of exchangeable ion. More specifically, K—A zeolite (K ion-exchange A-type zeolite) has a pore diameter of 0.3 nm, Na—A zeolite has a pore diameter of 0.4 nm, and Ca—A zeolite has a pore diameter of 0.5 nm. Each of these zeolites is commonly referred to as a molecular sieve 3A, 4A, and 5A, respectively.

Na—A, Ca—A, and like zeolites can be used singly as an adsorbent in the invention because they can adsorb both water and carbon dioxide. In contrast, K—A can remove water by adsorption but cannot adsorb carbon dioxide. Therefore, K—A needs to be used in combination with another carbon dioxide remover. In this case, any removers mentioned in the specification of the present invention are usable as a carbon dioxide remover, and, for example, Na—A and Ca—A, which are mentioned above; Na—X zeolite, chemical removers, which are described later; and the like can be mentioned.

In the invention, a zeolite having a pore diameter of 0.4 nm or more can be effectively used to limit the number of gold catalyst pretreatment filters to one. For example, the above-described Na—A and Ca—A are preferable. There is no limitation to the pore diameter insofar as it is 0.4 nm or more, and, for example, Na—X (Na ion-exchange X-type zeolite; commonly referred to as a molecular sieve 13X) with a pore diameter of 1.0 nm, and the like may be used. When Na—X is used, polar organic molecules with a comparatively large molecular diameter, such as nicotine and the like, can also be removed by adsorption, and the effect as a prefilter is higher compared with a case where Na—A or Ca—A is used.

Zeolite is not limited to the above-mentioned commercially available “molecular sieves”. Zeolite is also not limited in its framework structure insofar as the pore diameter of the zeolite is 0.4 nm or more. For example, Y-type, L-type, ZSM-5, mordenite-type, offretite-type, ferrierite type, clinoptilolite-type zeolites, etc., can be mentioned in addition to the above-described A-type and X-type zeolites. Moreover, zeolite is not limited in its exchangeable ion type, insofar as the ion(s) can be prepared with a common ion exchange method.

In the chemical removal method, carbon dioxide, which is a weak acidic substance, is made to react with a basic substance, and removed. Any substances with high absorption ability irrespective of whether they are in a solid or liquid form, are usable. Soda lime can be mentioned as a solid carbon dioxide absorbent (the carbon dioxide absorption amount is stipulated to be at least 20 to 30% according to JIS K8603). Among liquid absorbents, an aqueous diethanoleamine solution, an aqueous potassium carbonate solution, etc., can be mentioned as liquid absorbents with a high adsorption ability. When the vapor concentration is higher than that usually contained in ambient air after carbon dioxide is removed by a method using either a solid or liquid absorbent, water needs to be separately removed using a desiccant. Examples of desiccants include silica gel, calcium chloride, diphosphorous pentoxide, etc.

Many physical carbon dioxide adsorbents and chemical carbon dioxide absorbents are able to adsorb carbon dioxide and water, and in the presence of water, the absorption ability of carbon dioxide lowers. In order to avoid this problem, they may be mixed. However, the life of a carbon dioxide remover can be lengthened when the gas to be treated is passed through a water remover (desiccants) and then a carbon dioxide remover (i.e., two-stage pretreatment filters. Mentioned as a dehumidification agent in this regard are K—A type zeolite, silica gel, calcium chloride, diphosphorous pentoxide, etc.

Specific examples of the above-described two-stage pretreatment filters include K—A zeolite (first stage) and Na—X zeolite (second stage) or calcium chloride (first stage) and soda lime (second stage), etc.

Two-stage pretreatment filters can also be provided for another purpose. In the case of a combustion gas of organic matter containing various kinds of organic gas components, for example, the combustion gas is treated with activated carbon to remove the organic gas components therefrom and then treated with a combustion gas with a carbon dioxide remover (i.e., two-stage pretreatment filters), thereby lengthening the life of the carbon dioxide removal agent. In this case, since activated carbon is hydrophobic, the carbon dioxide remover in the second stage also chiefly removes water. Specific examples of such two-stage pretreatment filters include activated carbon (first stage) and Na—X zeolite (second stage); activated carbon (first stage) and Ca—A zeolite (second stage); activated carbon (first stage) and soda lime (second stage), etc.

Carbon dioxide and water are effectively removed from a gas containing carbon monoxide by the use of such carbon dioxide and water remover.

Gold Nanoparticle Catalyst

The gold nanoparticle catalyst used in the invention has a structure in which gold particles are supported on a metal oxide carrier. More specifically, nanosized gold particles are uniformly supported on the surface of a metal oxide carrier. The average particle diameter of the gold particles may be in the range of not less than the size of a gold atom and not more than about 25 nm, and preferably about 1 to about 10 nm. The average particle diameter of the gold particles is determined by a transmission electron microscopy.

Examples of metal oxides on which gold particles are supported include a single metal oxide selected from the group consisting of zinc oxide, iron oxide, copper oxide, lanthanum oxide, titanium oxide, cobalt oxide, zirconium oxide, magnesium oxide, beryllium oxide, nickel oxide, chromium oxide, scandium oxide, cadmium oxide, indium oxide, tin oxide, manganese oxide, vanadium oxide, cerium oxide, aluminum oxide, and silicon oxide; complex oxides comprising two or more metals selected from the group consisting of zinc, iron, copper, lanthanum, titanium, cobalt, zirconium, magnesium, beryllium, nickel, chromium, scandium, cadmium, indium, tin, manganese, vanadium, cerium, aluminum, and silicon; etc. The above-mentioned single metal oxides and complex oxides can be mixed, as required.

The content of gold in the gold nanoparticle catalyst may be about 0.1 to 30% by weight based on the total amount thereof, and preferably about 0.1 to about 10% by weight in view of the catalyst activity from the usage of gold.

The form of the gold nanoparticle catalyst can be suitably selected according to the purpose of use, and, for example, powders, granules, pellets, honeycombs, etc., can be mentioned. Among the above, when mixed with a carbon dioxide and water remover, the gold nanoparticle catalyst preferably has the form of particles, considering the ease of forming a uniform mixture. When the gold nanoparticle catalyst is in the form of particles, the average particle diameter thereof is about 0.05 to about 1 mm and preferably about 0.05 to about 0.2 mm.

The specific surface area of the gold nanoparticle catalyst is usually about 1 to about 800 m²/g, and preferably about 5 to about 300 m²/g as measured by the BET method.

Nanosized particles of gold are supported on a metal oxide by one of the following known methods:

Coprecipitation method (Japanese Unexamined Patent Publication No. 1985-238148, etc.)

Deposition-precipitation method (Japanese Unexamined Patent Publication No. 1991-97623, etc.)

Colloid mixing method (Tsubota S., et al., Catal. Lett., 56 (1998) 131)

Gas phase grafting (Japanese Unexamined Patent Publication No. 1997-122478, etc.)

Liquid phase grafting (Okamura M., et al., Chem. Lett., (2000) 396).

The following compounds can be mentioned as a starting material. Mentioned as a gold precursor are compounds that are evaporated by heating, such as water-soluble gold compounds (e.g., gold chloride), acetyl acetylacetonato complexes (e.g., gold acetylacetonato complex, etc.), etc.

Examples of a starting material of a metal oxide include nitrate, sulfate, acetate, chloride, and the like of various metals. More specifically, nitrates such as cerium nitrate, zirconium nitrate, and the like; sulfates such as titanium sulfate, and the like; chlorides such as cerium chloride, titanium trichloride, titanium tetrachloride, and the like; etc., can be mentioned.

In the known methods described above, the precipitate is deposited, and then washed with water, followed by drying. In order to finally transform the gold into a metal form, the precipitate may be heat-treated in an oxygen atmosphere or in a reducing gas. The oxygen atmosphere refers to air or a mixed gas in which oxygen is diluted with nitrogen, helium, argon, etc. Usable as the reducing gas are about 1 to about 10 vol % hydrogen gas, carbon monoxide gas, and the like which are diluted with nitrogen gas. The heat treatment temperature may be suitably selected from the known reduction condition range and is preferably about room temperature to about 600° C. In order to obtain stable and fine gold particles, the temperature range of about 200 to about 400° C. is more preferable. The heat treatment duration is preferably about 1 to 12 hours.

This gold nanoparticle catalyst can efficiently convert carbon monoxide to carbon dioxide through oxidation.

II. Carbon Monoxide Removal Method

The method for removing carbon monoxide of the invention comprises treating a gas with a catalyst for removing carbon monoxide, i.e., the above-mentioned gold nanoparticle catalyst, and carbon dioxide and water remover. In this treatment, the gas to be treated may be brought into contact with a mixture of the gold nanoparticle catalyst with the carbon dioxide and water remover. Alternatively, the gas to be treated may be treated with the carbon dioxide and water remover, and then brought into contact with the gold nanoparticle catalyst.

For a gas to be treated in which high concentrations of carbon dioxide and water have been previously contained, the latter treatment using the carbon dioxide and water remover as a prefilter is effective. Moreover, when the carbon monoxide content is high, it is effective to mix the carbon dioxide and water remover with the catalyst, considering the fact that the catalyst is influenced by carbon dioxide generated by a reaction.

A mixture of the gold nanoparticle catalyst with the carbon dioxide and water remover can be prepared by mixing, for example, a powdered gold nanoparticle catalyst with a powdered carbon dioxide and water remover by known methods. For example, a mortar, mixer, etc., may be used for stirring and mixing.

In the carbon monoxide removing catalyst of the invention, the content ratio of the gold nanoparticle catalyst to the carbon dioxide and water remover may be suitably determined. For a sufficient carbon monoxide removal effect, it is preferable to use the carbon dioxide and water remover in an amount equal to or larger than that of the gold nanoparticle catalyst. More specifically, the weight ratio of the gold nanoparticle catalyst to the carbon dioxide and water remover may be about 1:1 to about 1:100.

According to the method for removing carbon monoxide of the invention, carbon dioxide and moisture are effectively removed from a gas to be treated containing carbon monoxide, carbon dioxide, and moisture (e.g., actual air, synthetic air containing oxygen and inert gas, a combustion gas of organic matter, etc.), thereby suppressing the deactivation of the gold nanoparticle catalyst that oxidizes the carbon monoxide to form carbon dioxide in order to lengthen the catalyst life. Examples of carbon dioxide targeted in the invention include not only carbon dioxide contained in the air but also carbon dioxide generated by a reaction. In the case of a combustion gas of organic matter, various gas components are contained in addition thereto. Examples of an organic matter to be burned include, but are not limited to, tobacco, wood, plastics, fuels, etc.

Examples of specific components of a gas to be treated include the following components:

(A) essential gas components: an inert gas, such as carbon monoxide, vapor, oxygen, nitrogen, etc.;

(B) Semi-essential gas components: carbon dioxide (which is not necessarily contained in the gas to be treated, and may be generated by the catalyst oxidation reaction of carbon monoxide);

(C) Additional gas components: other gas components generated by combustion of organic matter (methane, isoprene, ammonia, acetaldehyde, nitrogen oxide, hydrogen cyanide, etc.).

The method of the invention is applied to the case for removing carbon monoxide from a gas having composition (A) using the gold nanoparticle catalyst, thereby lengthening the catalyst life of the gold nanoparticle catalyst. The effect is demonstrated also when (B) and (C) components are contained.

The carbon monoxide concentration of the gas to be treated may be chemically equivalent to or less than the oxygen concentration in the gas (about 20% in the case of air), i.e., 40% carbon monoxide to 20% oxygen. The carbon dioxide content and vapor content in the gas are not limited. The vapor amount may be determined in the range where vapor is not condensed at the temperature used.

The catalyst reaction temperatures can be suitably determined according to the catalyst type, the carbon monoxide content in the gas to be treated, etc. The present invention is effective at temperatures from −70 to 150° C. in view of the fact that the carbon monoxide removal reaction using the gold nanoparticle catalyst can be stably performed at temperatures of about −70 to about 350° C. and a problem with the accumulation of carbon dioxide and vapor components on the catalyst surface occurs at temperatures of 150° C. or less.

The gold nanoparticle catalyst can be operated at room temperature (e.g., about 10 to about 30° C., hereinafter the same shall apply). When the catalyst is used for a carbon monoxide removal device, etc., in this temperature range, no heating treatment is required, resulting in reduced energy consumption. In contrast, when the gold nanoparticle catalyst is heated, heat energy is required. However, when heated, carbon dioxide and water are not easily adsorbed on the surface of the gold nanoparticle catalyst. Thus, the catalyst life can be markedly lengthened by the combined use of the gold nanoparticle catalyst and the carbon dioxide and water remover. A suitable temperature range of the gold nanoparticle catalyst is about room temperature to about 100° C., and preferably about room temperature to about 80° C.

When the carbon dioxide and water remover is mixed with the gold nanoparticle catalyst, the operating temperature of the carbon dioxide and water remover is naturally the same as the catalyst temperature. When the gas treated with the carbon dioxide and water remover is brought into contact with the catalyst, the temperature of the gold nanoparticle catalyst can be set separately from the temperature of the carbon dioxide and water remover. For example, the gas is pretreated by the carbon dioxide and water remover (e.g., zeolite) at room temperature, and then brought into contact with the gold nanoparticle catalyst heated at 50 to 100° C., whereby the removal effect is higher than that obtained when both the treatments are performed at room temperature.

When the carbon dioxide and water remover, which is not mixed with the catalyst, is saturated and loses its removal ability, the catalyst effect can be recovered by replacing or regenerating only the carbon dioxide and water remover. The remover can be regenerated by flowing inert gas, flowing air (which is purer than the gas to be treated), reducing the pressure, heating, washing, drying, or the like methods. Among these, by heating, the remover can be remarkably effectively regenerated. More specifically, the carbon dioxide and water remover can be regenerated by heating it at about 50 to about 700° C. The purpose of removing only carbon dioxide and water by heating can be achieved by heating the remover at 50 to 250° C.

Since the carbon dioxide concentration and the water concentration are not completely reduced to zero even after the gas to be treated is passed through the carbon dioxide and water remover, it takes a longer time for the gold nanoparticle catalyst to lose its catalyst activity compared with the case where no carbon dioxide and water remover is used. A gold nanoparticle catalyst whose removal ability has been lost can be regenerated by heating. After the gold nanoparticle catalyst was brought into direct contact with a tobacco combustion gas and deactivated, not only carbon dioxide and water but also various poisonous substances, such as nicotine, were adsorbed on the catalyst. In order to recover the initial catalyst activity by regeneration through heating, this catalyst needs to be heated at about 350° C. However, when a gas reaches the catalyst after being treated with Na—X zeolite or the like as a prefilter and polar organic molecules with a comparatively large molecular diameter, such as nicotine and the like, are almost completely removed by adsorption, only carbon dioxide and water are adsorbed to the catalyst when it is deactivated, and the temperature for regenerating the catalyst through heating can be lowered to about 50 to about 250° C.

The method for removing carbon monoxide using the catalyst of the invention is carried out using the gold nanoparticle catalyst as a “thermal” catalyst (which means that the catalyst is not a photocatalyst) in the above-mentioned temperature range, and may be carried out under the following light irradiation conditions.

The gold nanoparticle catalyst used in the invention can further promote the oxidation of carbon monoxide by light irradiation, compared with the case where no irradiation light was performed. When the activity of the gold nanoparticle catalyst is lowered by contaminants present in the air, the catalyst can also be regenerated by light irradiation. Thus, when the gold nanoparticle catalyst is in contact with carbon monoxide gas, an oxidation promoting effect can be expected, and when it is not, a catalyst regeneration effect by light irradiation is demonstrated. Therefore, when the gold nanoparticle catalyst is irradiated with light, a high carbon monoxide removal effect can be maintained over a longer period of time than the case where the catalyst is not irradiated with light, when the carbon monoxide is in contact with the catalyst surface either intermittently or continuously.

The wavelength of light to be emitted can be suitably determined depending on the expected effect: the effect of promoting carbon monoxide oxidation or the effect of regenerating the catalyst. In general, by the use of light with a wavelength of about 1 to about 1000 nm, and preferably about 200 to about 700 nm, both the effects of promoting carbon monoxide oxidation and regenerating the gold nanoparticle catalyst can be attained.

Also when light irradiation is performed, any gold nanoparticle catalysts comprising a metal oxide of the above-described composition can be used. In particular, in order to attain the above-described photoinduced promotion effect on catalytic activity, titania, alumina, silica, zirconia, zinc oxide, ceria, manganese oxide, magnesia, etc., are preferable as a metal oxide component for the gold nanoparticle catalyst, and titania, alumina, silica, etc., are more preferable.

III. Applications

The catalyst for removing carbon monoxide of the invention is widely used as a filter (e.g., air purification filter). When the catalyst for removing carbon monoxide of the invention is used as an air purification filter, the catalyst may take whatever form suits the intended use, such as granules, honeycombs, beads, or fibers. Filters in such forms can be manufactured using known methods.

The above-mentioned air purification filter can also be used as a member of an air cleaner. Air cleaners may be provided with, for example, a particle-removal filter, the above-mentioned air purification filter, and, as required, a light source required for the above-described light irradiation. Any light sources can be used insofar as the light has a wavelength in which the above-described oxidation reaction of carbon monoxide can be promoted. For example, natural light, a high-pressure mercury (vapor) lamp, a low-pressure mercury (vapor) lamp, a black light, an excimer laser, a deuterium lamp, a xenon lamp, etc., are usable.

The above-described air purification filter can also be used as a gas mask for carbon monoxide and the like.

When the carbon monoxide removing catalyst of the invention is used as a filter, the catalyst may be positioned in such a manner that the gas to be treated is brought into contact with a mixture of the gold nanoparticle catalyst with the carbon dioxide and water remover, or may be positioned in such a manner that the gas to be treated is brought into contact and the carbon dioxide and water remover, and then with the gold nanoparticle catalyst.

### Effects of the Invention

When the gold nanoparticle catalyst is brought into contact with various poisonous substances, such as carbon dioxide and vapor, contained in the combustion gas of organic matter, the carbon monoxide removal performance is reduced. However, according to the carbon monoxide removal method of the present invention, the influence of carbon dioxide and water on the catalyst can be eliminated, thereby maintaining the activity of the gold nanoparticle catalyst at a high level over a long period of time.

Therefore, the method for removing carbon monoxide of the present invention is extremely useful in various fields in which carbon monoxide needs to be removed. More specifically, the carbon monoxide removal method of the invention is extremely useful for the following devices: air purifiers for use in air conditioners for living rooms, automobiles, etc., (air cleaners, air-conditioning equipment, devices for separating facilities for smokers and nonsmokers, etc.); filters for removing incomplete combustion gases generated in heating devices, boilers, etc.; carbon monoxide removal filter devices for gas masks; filter devices for removing carbon monoxide from a starting material gas for use in chemical plants, etc.; filter devices for removing carbon monoxide in a hydrogen production process for fuel reforming in a fuel cell.

### BRIEF DESCRIPTION OF THE DRAWINGS

FIG. 1 is a schematic view showing the outline of a device for evaluating catalyst life.

FIG. 2 is a graph showing changes with time in carbon monoxide and carbon dioxide concentrations in the reaction of Example 1.

FIG. 3 is a graph showing changes with time in carbon monoxide and carbon dioxide concentrations in the reaction of Comparative Example 1.

FIG. 4 is a schematic view showing the outline of a device for evaluating catalyst life using tobacco combustion gas.

FIG. 5 is a graph showing changes with time in carbon monoxide concentrations in the reactions of Example 8, and Comparative Examples 12 and 13.

### BEST MODE FOR CARRYING OUT THE INVENTION

Hereinafter, the present invention will be described in more detail with reference to Examples, but is not limited thereto.

In the Examples and Comparative Examples, a gold nanoparticle titanium-oxide catalyst prepared by method (1) was used throughout, and the catalyst life was evaluated by method (2).

(1) Preparation of a Gold Nanoparticle Catalyst (Gold/Titanium-Oxide Catalyst)

473 mmol of chlorauric acid [HAuCl₄.4H₂O] was dissolved in 750 mL of distilled water. The solution was heated to 70° C., and an aqueous solution of NaOH was added dropwise to adjust the pH to 7. 3.0 g of titanium-oxide powder was added thereto, and the mixture was stirred at 70° C. for 1 hour. Then, the result was cooled to room temperature and the precipitate was sufficiently washed with distilled water, followed by drying. The dried matter was calcined at 400° C. in air for 4 hours, providing a gold/titanium—oxide catalyst [Au/TiO₂, 3 wt % of gold loading]. The gold nanoparticle catalyst obtained was stored in a screw cap bottle until immediately before it was used.

(2) Catalyst-Life Test Method

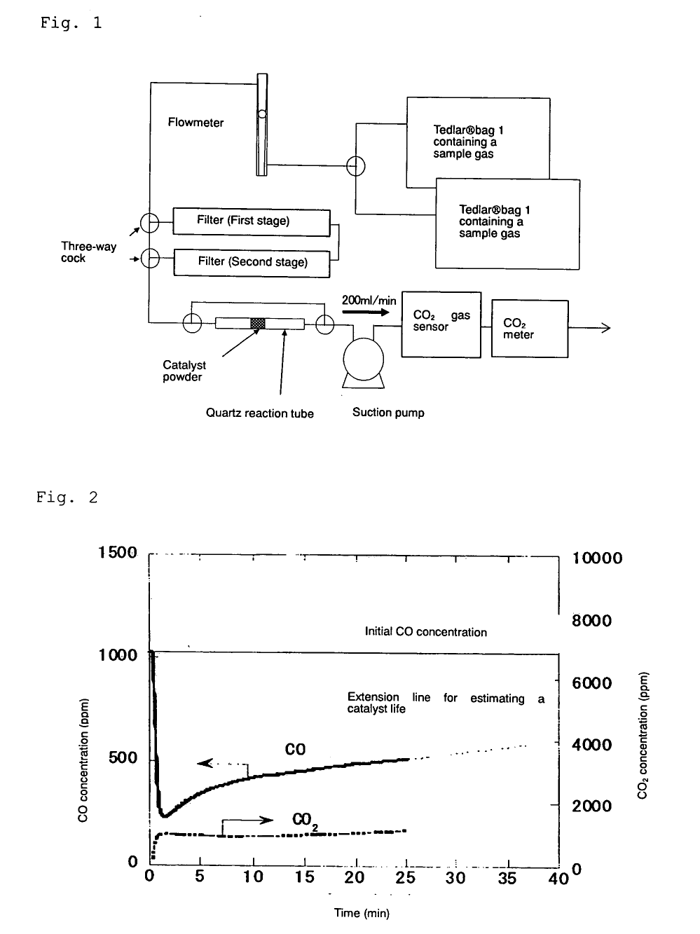

The catalyst-life test was performed using the device shown in FIG. 1. A sample gas contained in a tedlar® bag was passed through adsorbent-packed filter columns 1 and 2 (one filter column 1 when using one type of adsorbent), and then led into a catalyst reaction tube. The catalyst reaction tube outlet was connected to the inlet of a suction pump so that the gas in the tedlar® bag was aspirated. Since a suction pump (GL science SP 208) capable of automatically adjusting the suction power according to pressure loss was used, a constant flow rate was maintained without being influenced by the filling condition of the adsorbent(s) in the filter(s) and the catalyst powder. A carbon monoxide gas sensor and carbon dioxide concentration meter were connected to the outlet of the catalyst reaction tube, and the concentration was measured. 15 mg or 67 mg of gold/titanium oxide prepared in (1) was mixed with 500 mg of quartz sand, and the mixture was placed in a quartz reaction tube with an inner diameter of 6 mm. The result was used as a catalyst.

The measurement was performed as follows. First, a cock(s) was set up so that the gas passed through the adsorbent filter(s) and did not pass through the catalyst reaction tube (i.e., bypassed the tube). Then, the suction pump was operated to flow the gas at 200 mL/min.

After the carbon monoxide concentration of the gas that had passed through the adsorbent filter(s) became constant, the cock of the catalyst reaction tube was switched so that the test gas passed through the catalyst, which was regarded to be the reaction start time.

Under conditions where the carbon monoxide concentration was low and the catalyst amount was sufficient, after a constant conversion was maintained for several hours to several days, the conversion began to reduce until it finally reached zero. However, under the reaction conditions, the carbon monoxide concentration and the concentration of the accompanying poisonous substance were high and the catalyst amount was small. Therefore, although the conversion immediately after the start of the reaction was close to 100%, the conversion began to decrease after several minutes. The time when the conversion reached zero was defined as the catalyst life. When the conversion did not reach zero after a given period of time passed, the catalyst life was estimated by extending the activity curve.

### Test Example 1

The catalyst-life test was performed as shown in Example 1 and Comparative Example 1.

### Example 1

Air comprising, in addition to carbon monoxide, only carbon dioxide and water as poisonous substances was prepared according to the following procedure, and a catalyst reaction test was performed using the air to confirm the effects of the invention.

10 L of indoor air (25.5° C., 70% of humidity) was collected in the tedlar® bag using the suction pump (manufactured by GL science, SP208). Pure carbon monoxide and pure carbon dioxide were inserted therein using a gas-tight syringe so that the carbon monoxide concentration was about 1000 ppm and the carbon dioxide concentration was about 7200 ppm.

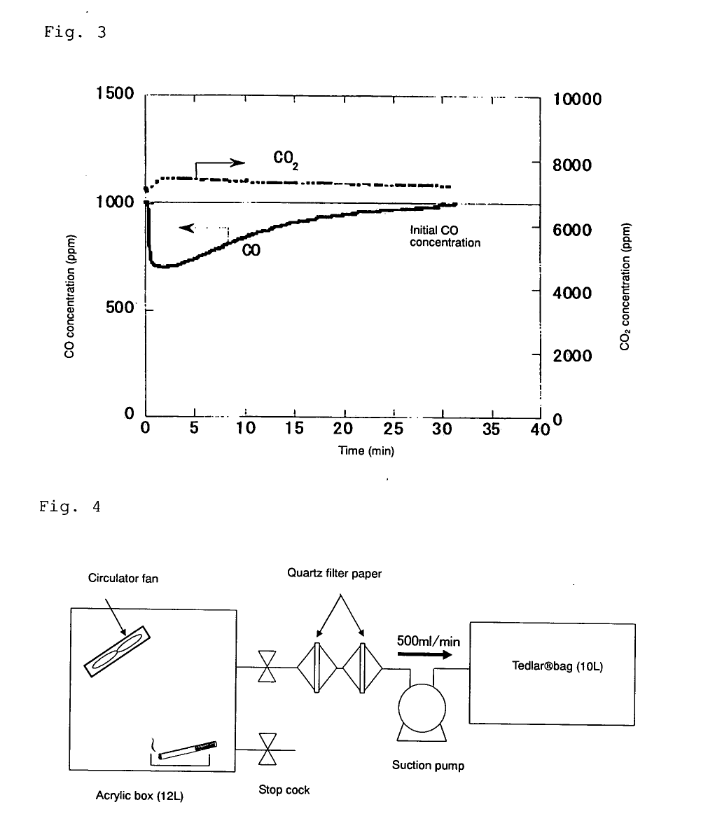

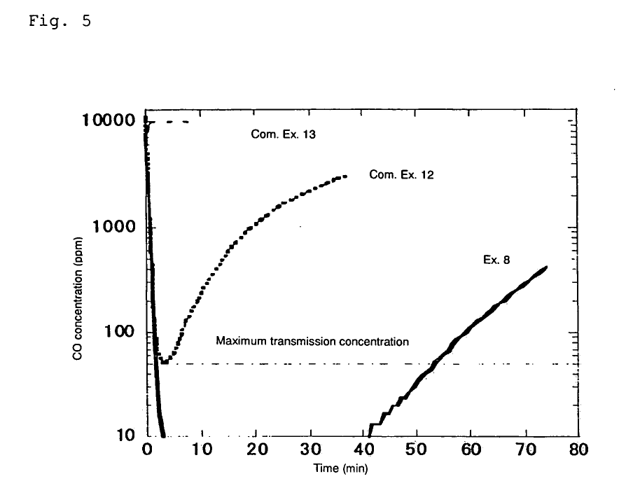

The filter column(s) of FIG. 1 was filled with 50 mL of Na—X zeolite (manufactured by Kishida Chemical Co., Ltd., molecular sieve 13×, 1/16 pellet) that was stored in a reagent bottle as a carbon dioxide and water remover. Separately, 15 mg of gold/titanium—oxide catalyst powder that was stored in a screw cap bottle was diluted with quartz sand, and a total of 500 mg of the dilution was placed in the catalyst reaction tube. In this Test Example, since a small amount of catalyst was used under accelerated test conditions, quartz sand was used as a diluent to avoid the formation of void in the reaction tube, thereby preventing the gas from passing through the tube without being adsorbed. The catalyst-life test was performed according to the above-described procedure without preheating the catalyst or the carbon dioxide and water remover. The reaction results are shown in FIG. 2 and Table 1.

TABLE 1

| | | | | | | | | | Catalyst life |
|---|---|---|---|---|---|---|---|---|---|
| | Prefilter | CO concentration/ppm | | | CO₂ concentration/ | | | Catalyst | calculated in |
| | (each adsorbent | (CO conversion/%) | | | ppm | | | life | terms of 50 ppm |
| | capacity/ml) | 0 min | 5 min | 25 min | 0 min | 5 min | 25 min | Tₐ/min | Tₙ/days |
| Ex. 1 | Na-X zeolite (50) | 1025 (0.0) | 343 (66.5) | 512 (50.0) | 213 | 951 | 1127 | 105 | 4.0 |
| Com. | None | 1004 (0.0) | 745 (25.8) | 972 (3.2) | 7113 | 7430 | 7254 | 30 | 1.1 |
| Ex. 1 | | | | | | | | | |

The carbon monoxide concentration before the reaction was started was 1025 ppm, but immediately after the reaction was started, it dropped to about 230 ppm. Then, the carbon monoxide concentration gradually increased. The value of the carbon monoxide conversion (Cₜ) at the time of “t” in Table 1 was calculated as follows:
Cₜ(%)=([CO]ₜ₀−[CO]ₜ)/[CO]ₜ₀×100

In this equation, [CO]ₜ₀ refers to the carbon monoxide concentration at the time of zero and [Co]ₜ refers to the carbon monoxide concentration at the reaction time “t”.

During the reaction test, the carbon dioxide concentration was 1130 ppm or less, which was much lower than the test gas concentration of 7200 ppm. This shows that carbon dioxide originally contained in the test gas other than carbon dioxide generated by the catalyst reaction is almost completely removed by Na—X zeolite adsorption.

The catalyst life (Ta) was defined as the time until the carbon monoxide concentration returned to the concentration before the reaction was started (the time until the carbon monoxide conversion reached zero). In this Example, the carbon monoxide conversion did not reach zero even after a 25-minute measurement was performed. In FIG. 1, the carbon monoxide concentration increased linearly, starting 10 minutes after the reaction was started. The catalyst life was estimated to be 105 minutes by extending this line until the initial CO concentration, [CO]ₜ₀, was reached.

The catalyst life (corresponding catalyst life, Tn) under the normally assumed catalyst reaction conditions when the catalyst was used as an air cleaner was obtained in terms of the catalyst life (Ta) under the accelerated conditions calculated by the following method:
Tn(days)=Ta(min)×(Fa/Fn)/(60×24)
Fa(mL−CO/h/g−catal.)=0.8×[CO]ₜ₀(ppm)
Fn(mL−CO/h/g−catal.)=15

In the above equations, Fa refers to the carbon monoxide flow rate per gold/titanium-oxide catalyst weight in the accelerated test; [Co]ₜ₀ refers to the initial carbon monoxide concentration in the accelerated test; and Fn refers to the carbon monoxide flow rate per gold/titanium-oxide catalyst weight under normally assumed reaction conditions (non-accelerated conditions), which were calculated from the amount of the catalyst, the total gas flow rate, and the initial carbon monoxide concentration (50 ppm assumed).

### Comparative Example 1

The catalyst-life test was performed using a test gas prepared under the same conditions as in Example 1 without using a prefilter. More specifically, in the device of FIG. 1, a three-way cock of a filter column was switched so that the gas bypassed the filter. Separately, 15 mg of a gold/titanium-oxide catalyst powder that was stored in a screw cap bottle was diluted with quartz sand, and then a total of 500 mg of the dilution was placed in the catalyst reaction tube. The catalyst-life test was performed according to the above-described procedure without preheating the catalyst.

The reaction results are shown in FIG. 3 and Table 1. The carbon monoxide conversion after the reaction was started is lower than that of Example 1, and returns, in 30 minutes (Ta=30 min), to the initial carbon monoxide concentration before the reaction was started. Since no prefilter adsorbing carbon dioxide or water is provided, the carbon dioxide contained in the tobacco combustion gas reaches the catalyst without being changed. Therefore, the carbon dioxide concentration at the catalyst outlet is always as high as 7000 ppm or higher. In this Comparative Example, deactivation of the catalyst is possibly caused by carbon dioxide and water, and while in Example 1, the lengthening of the catalyst life is possibly caused by the removal of both carbon dioxide and water.

### Test Example 2

Next, tobacco combustion gas was prepared as an example of a combustion gas of an organic matter, and the catalyst-life test was performed.

Preparation of Tobacco Combustion Gas

As a tobacco combustion gas preparing device, an ash tray and an air circulator fan were installed in an acrylic desiccator having an inner volume of 12 L. Two opening/closing cocks were provided in the desiccator in such a manner that one of the two cocks served as a tobacco combustion gas outlet for sucking the tobacco combustion gas using a suction pump (manufactured by GL Science, SP208) and the other cock served as an air inlet for introducing air into the desiccator to maintain a normal pressure inside the desiccator during suction using a suction pump. Between the tobacco combustion gas outlet and the suction pump, two-stage quartz filter papers (Whatman QMA quartz fiber filter paper) were provided) to remove particle substances. In the stage following to the filters, the gas pipe was connected to the suction port of the pump and a 10-L tedlar® bag was connected, as a gas-collecting bag, to the outlet of the pump.

The tobacco combustion gas was prepared as follows. A cigarette (trade name: Mild Seven, manufactured by Japan Tobacco, Inc.) was lit, and placed in the ash tray. Then, the door lid of the desiccator was closed and the cigarette was allowed to stand therein for about 8 minutes until the cigarette was completely extinguished. After the burning ceased naturally, the two cocks were opened, the suction pump was operated for 10 minutes at 500 mL/min, and 5 L of the tobacco combustion gas was collected in a tedlar® bag having a capacity of 10 L. Subsequently, the paper filter was detached from the sampling pump, and the inlet of the sampling pump was released to the atmosphere. Then, the sampling pump was operated again for 10 minutes at 500 mL/min, and 5 L of indoor air was added to the tedlar® bag. Thus, 10 L of the tobacco combustion gas was prepared in the 10-L tedlar® bag. For the tobacco combustion gas prepared according to this method, the average carbon monoxide concentration was 1100 to 1300 ppm and the average carbon dioxide concentration was 6000 to 7000 ppm.

The tobacco combustion gas prepared above was subjected to the carbon monoxide removal test in the following conditions as in Examples 2 to 7 and Comparative Examples 2 to 11. The results are shown in Table 2.

TABLE 2

| | | | | | | | | | | Catalyst life |
|---|---|---|---|---|---|---|---|---|---|---|
| | | | | | | CO₂ | | | | Tₙ |
| | | CO concentration/ppm | | | | concentration/ | | | Catalyst | calculated |
| | Prefilter | (CO conversion/%) | | | | ppm | | | life | in terms of |
| | (each adsorbent volume/ml) | 0 min | 5 min | | 25 min | 0 min | 5 min | 25 min | Tₐ/min | 50 ppm/days |
| Ex. 2 | Na-X zeolite (100) | 1140 | 61 | (94.6) | 92 | 62 | 1081 | 1066 | 825 | 34.8 |
| | | (0.0) | | | (91.9) | | | | | |
| Ex. 3 | Na-X zeolite (50) | 1120 | 392 | (65.0) | 746 | 80 | 891 | 495 | 160 | 6.6 |
| | | (0.0) | | | (33.4) | | | | | |
| Ex. 4 | Ga-A zeolite (100) | 1200 | 175 | (85.4) | 560 | 52 | 1194 | 744 | 200 | 8.9 |
| | | (0.0) | | | (53.3) | | | | | |
| Ex. 5 | First stage: Activated carbon G2x (50) | 1100 | 272 | (75.3) | 460 | 72 | 984 | 778 | 315 | 12.8 |
| | Second stage: Na-X zeolite (50) | (0.0) | | | (58.2) | | | | | |
| Ex. 6 | First stage: Activated carbon G2x (50) | 1015 | 179 | (82.4) | 323 | 79 | 984 | 803 | 250 | 9.4 |
| | Second stage: Ca-A zeolite (50) | (0.0) | | | (68.2) | | | | | |
| Ex. 7 | First stage: Activated carbon G2x (50) | 1020 | 836 | (18.0) | 958 | 122 | 267 | 164 | 176 | 6.6 |
| | Second stage: Soda lime (50) | (0.0) | | | (6.1) | | | | | |
| Com. Ex. 2 | Activated carbon G2x (100) | 1015 | 379 | (62.7) | 568 | 629 | 1323 | 5010 | 75 | 2.8 |
| | | (0.0) | | | (44.0) | | | | | |
| Com. Ex. 3 | Activated carbon G2x (50) | 1105 | 261 | (76.4) | 910 | 885 | 4020 | 6390 | 26 | 1.1 |
| | | (0.0) | | | (17.6) | | | | | |
| Com. Ex. 4 | Activated carbon for removing | 1110 | 201 | (81.9) | 766 | 501 | 1817 | 6345 | 73 | 3.0 |
| | sulfur-based neutral gas | (0.0) | | | (31.0) | | | | | |
| | components GS2x (100) | | | | | | | | | |
| Com. Ex. 5 | Activated carbon for removing | 1155 | 444 | (61.6) | 680 | 841 | 1756 | 6580 | 40 | 1.7 |
| | acid gas components in the | (0.0) | | | (41.1) | | | | | |
| | presence of ammonia GH2x (100) | | | | | | | | | |
| Com. Ex. 6 | Activated carbon for simultaneously | 1265 | 1410 | (<0) | | 6020 | 6540 | | 24 | 1.1 |
| | removing acid and basic components | (0.0) | | | | | | | | |
| | GM2x (100) | | | | | | | | | |
| Com. Ex. 7 | Activated carbon for removing | 1130 | 1095 | (3.1) | | 7030 | 6060 | | 7 | 0.3 |
| | aldehyde gas components GAAx (100) | (0.0) | | | | | | | | |
| Com. Ex. 8 | Activated carbon for removing | 1110 | 1185 | (<0) | | 6410 | 6280 | | 4 | 0.2 |
| | acid gas components GS1x (100) | (0.0) | | | | | | | | |
| Com. Ex. 9 | Activated carbon for removing | 1230 | 1240 | (<0) | | 6190 | 6410 | | 4 | 0.2 |
| | basic gas components GTsx (100) | (0.0) | | | | | | | | |
| Com. Ex. | K-A zeolite (100) | 1255 | 1160 | (7.6) | | 4560 | 6380 | | 7.7 | 0.4 |
| 10 | | (0.0) | | | | | | | | |
| Com. Ex. | None | 1475 | 1485 | (<0) | | | | | 2.6 | 0.1 |
| 11 | | (0.0) | | | | | | | | |

### Example 2

100 mL of Na—X zeolite was placed in the filter column of FIG. 1 in the same manner as in Example 1. Separately, 15 mg of gold/titanium-oxide powder was diluted with quartz sand, and a total of 500 mg of the dilution was placed in the catalyst reaction tube. A tedlar® bag was filled with the tobacco combustion gas prepared according to the above-described method. The catalyst-life test was performed without preheating the zeolite and catalyst following the above-described procedure.

### Example 3

50 mL of Na—X zeolite was placed in the filter column and the catalyst-life test was performed in the same manner as in Example 2.

### Example 4

100 mL of Ca—A zeolite was placed in the filter column and the catalyst-life test was performed in the same manner as in Example 2.

### Example 5

50 mL of activated carbon (manufactured by Japan EnviroChemicals, Ltd., G2x) was placed in the first-stage filter column and 50 mL of Na—X zeolite was placed in the second-stage filter column. The catalyst-life test was performed in the same manner as in Example 2.

### Example 6

50 mL of activated carbon (manufactured by Japan EnviroChemicals, Ltd., G2x) was placed in the first-stage filter column and 50 mL of Ca—A zeolite was placed in the second-stage filter column. The catalyst-life test was performed in the same manner as in Example 2.

### Example 7

50 mL of activated carbon (manufactured by Japan EnviroChemicals, Ltd., G2x) was placed in the first-stage filter column and 50 mL of soda lime (manufactured by Kishida Chemical Co., Ltd., soda lime, particles, No. 1) was placed in the second-stage filter column. The catalyst-life test was performed in the same manner as in Example 2.

### Comparative Example 2

100 mL of activated carbon (manufactured by Japan EnviroChemicals, Ltd., G2x) was placed in the filter column and the catalyst-life test was performed in the same manner as in Example 2.

### Comparative Example 3

50 mL of activated carbon (manufactured by Japan EnviroChemicals, Ltd., G2x) was placed in the filter column and the catalyst-life test was performed in the same manner as in Example 2.

### Comparative Example 4

100 mL of activated carbon for removing sulfur-based neutral gas components (manufactured by Japan EnviroChemicals, Ltd., GS2x) was placed in the filter column and the catalyst-life test was performed in the same manner as in Example 2.

### Comparative Example 5

100 mL of activated carbon for removing acid gas components in the presence of ammonia (manufactured by Japan EnviroChemicals, Ltd., GH2x) was placed in the filter column and the catalyst-life test was performed in the same manner as in Example 2.

### Comparative Example 6

100 mL of activated carbon for simultaneously removing acid and basic components (manufactured by Japan EnviroChemicals, Ltd., GM2x) was placed in the filter column and the catalyst-life test was performed in the same manner as in Example 2.

### Comparative Example 7

100 mL of activated carbon for removing aldehyde gas components (manufactured by Japan EnviroChemicals, Ltd., GAAx) was placed in the filter column and the catalyst-life test was performed in the same manner as in Example 2.

### Comparative Example 8

100 mL of activated carbon for removing acid gas components (manufactured by Japan EnviroChemicals, Ltd., GS1x) was placed in the filter column and the catalyst-life test was performed in the same manner as in Example 2.

### Comparative Example 9

100 mL of activated carbon for removing basic gas components (manufactured by Japan EnviroChemicals, Ltd., GTsx) was placed in the filter column and the catalyst-life test was performed in the same manner as in Example 2.

### Comparative Example 10

100 mL of K—A zeolite (manufactured by Kishida Chemical Co., Ltd., molecular sieve 3A, 1/16 pellet) was placed in the filter column and the catalyst-life test was performed in the same manner as in Example 2.

### Comparative Example 11

The catalyst-life test was performed in the same manner as in Example 2 under the conditions where the filter column was bypassed so that the sample gas was brought into direct contact with the catalyst.

Table 2 summarizing the results of Examples 2 to 7 and Comparative Examples 2 to 11 reveals the following.

Under the conditions where no filter was used, as in Comparative Example 11, the catalyst life is remarkably short compared with the case where the test gas of Comparative Example 1 comprising carbon monoxide, carbon dioxide, and air was used (Ta=30 min in Comparative Example 1, Ta=2.6 min in Comparative Example 11). This is possibly caused by various poisonous components contained in the tobacco combustion gas, in addition to the poisonous effect caused by carbon dioxide or water.

Activated carbon and impregnated activated carbon were used as a filter so as to remove these various poisonous components (Comparative Examples 2 to 9). Although the catalyst life was extended in both cases, compared with the case where no filter was used, Ta did not exceed 100 minutes in any of the Comparative Examples.

In Comparative Examples 2 to 9, various kinds of activated carbon and impregnated activated carbon which are commercially available for a variety of applications were used so as to selectively remove specific poisonous substances contained in the tobacco combustion gas. However, no extension of the catalyst life was observed.

The correlation between the carbon dioxide concentrations at the outlet and Ta was confirmed. More specifically, when the carbon dioxide adsorption capacity was slight and the carbon dioxide concentration at 0 minute (i.e., when the reaction was started) was 6000 ppm or higher (Comparative Examples 6 to 9), the catalyst life was comparatively short (Ta=4 to 24 min). In contrast, when the carbon dioxide adsorption capacity still remained 5 minutes after the reaction was started (Comparative Examples 2, 4, and 5, with 2000 ppm or less of carbon dioxide concentration 5 minutes after the reaction was started), the catalyst life was relatively extended (Ta=40 to 75 min).

When zeolite or soda lime, which is a carbon dioxide and water remover with high adsorption capacity, was included in the filter material (Examples 2 to 7), the catalyst life was clearly extended (Ta>150min). During the reaction, no carbon dioxide concentration exceeding 1200 ppm was observed, which showed that carbon dioxide was possibly produced only by the catalyst reaction. When the catalyst activity measurement was complete, the cock was switched so that the catalyst reaction tube was bypassed, and then the carbon dioxide concentration after passing through only the filter was measured. Thus, it was confirmed that the carbon dioxide concentration was equivalent to or less than the carbon dioxide concentration when the reaction was started (i.e., at 0 minute) of Table 2.

Even zeolite was not effective for the case where the pore diameter was smaller than 0.4 nm. As shown in Comparative Example 10, K—A zeolite has a pore diameter as small as 0.3 nm and can adsorb water but not carbon dioxide.

Comparing the cases where various zeolites with different pore diameters of 0.4 nm or larger were singly used (Examples 2 to 4), Na—X zeolite with a pore diameter of 1.0 nm (Example 2) exhibited a higher effect than Ca—A zeolite with a pore diameter of 0.5 nm (Example 4). This is possibly because the Na—X zeolite removed poisonous substances with relatively large-sized molecules, such as nicotine, which the Ca—A zeolite did not adsorb.

As shown in Examples 5 and 6, when activated carbon was used in the first stage and Ca—A or Na—X zeolite was used in the second stage, the catalyst life was extended longer than the total of the catalyst life obtained when 50 mL of each adsorbent was separately used. This is possibly because organic poisonous substances and the like were removed by activated carbon, and then treated with zeolite, thereby reducing the burden on the zeolite.

### Test Example 3

Hereinafter, Examples and Comparative Examples assuming that the present invention is applied to a gas mask will be described.

### Example 8

According to the regulation of the “JIS T 8152 gas respirators”, indoor air comprising 10000 ppm of carbon monoxide was used as a test gas. 10 L of the indoor air was collected in a tedlar® bag using a suction pump (manufactured by GL science, SP208). Pure carbon monoxide was injected into this tedlar® bag using a gas-tight syringe so that the carbon monoxide concentration was about 10000 ppm, and this tedlar® bag was placed in the device of FIG. 1.

In gas masks, it is assumed that a catalyst is preheated together with a carbon dioxide and water remover, then sealed and shipped, and unsealed immediately before use. Thus, a catalyst preheated according to the following procedure was used in this Example.

67 mg of gold/titanium-oxide powder stored in a screw cap bottle was mixed with 500 mg of Na—X zeolite sieved to a particle size of 12 to 30 mesh, and the mixture was placed in a catalyst reaction tube. With a different device from the one of FIG. 1, a mixed gas with a composition of 20% oxygen and 80% helium (supplied from a gas cylinder) was flowed at 100 mL/min while raising the temperature to 200° C. in 10 minutes, and then the temperature was maintained at 200° C. for 10 minutes. By monitoring the gas at the outlet of the reaction tube with a mass spectrometer, the desorption of carbon dioxide and water was confirmed. After being cooled to room temperature, the reaction tube was removed and placed in the device of FIG. 1.

A cock(s) was set up so that the test gas did not pass through (bypass) both the filter column and the catalyst reaction tube of FIG. 1, the suction pump was operated, and the test gas was circulated at 200 mL/min. After the carbon monoxide concentration at the outlet measured by a carbon monoxide gas sensor was stabilized, the cock of the catalyst reaction tube was switched so that the test gas passed through the catalyst, which was defined as the reaction start time.

The reaction results are shown in FIG. 5. The initial carbon monoxide concentration was 10000 ppm. The concentration dropped to 50 ppm or less within 2 minutes from the time the reaction was started. The carbon monoxide outlet concentration of 50 ppm or less was maintained for 53 minutes.

As the test conditions in this Example, 67 mg of gold/titanium oxide as the catalyst and 500 mg of Na—X zeolite were used at the sample gas flow rate of 200 mL/min. In the test method of JIS T 8152, the test gas is flowed at 30 L/min, which is 150 times the flow rate of this Example. Assuming that the same reaction results are obtained when the ratio of the test gas flow rate to the catalyst amount is the same, the conditions of this Example would be equivalent to those of the case where the test according to JIS T 8152 (test conditions: 30 L/min of sample gas flow rate, 10 g of gold/titanium-oxide catalyst amount, and 75 g of Na—X zeolite) was carried out on a small scale of 1/150. The carbon monoxide outlet concentration of gas masks with chin type or mouthpiece type canister needs to maintained at 50 ppm or less for 30 minutes or more, which is satisfied in this Example, wherein a carbon monoxide outlet concentration of 50 ppm or less was maintained for 53 minutes.

### Comparative Example 12

A test in which only a gold/titanium-oxide catalyst was used and no Na—X zeolite was used was performed according to the following procedure. 67 mg of gold/titanium-oxide powder stored in a screw cap bottle was mixed with 500 mg of quartz sand. The mixture was placed in a catalyst reaction tube. In the same manner as in Example 8, the catalyst was preheated, and the reaction tube was then placed in the device of FIG. 1. The catalyst-life test was performed under the same conditions as in Example 8. The reaction results are shown in FIG. 5. The carbon monoxide concentration dropped to 50 ppm 3 minutes after the reaction was started. Immediately after this drop, however, the carbon monoxide concentration increased. Thus, the concentration of 50 ppm or less was not maintained for the required period of time.

### Comparative Example 13

A test in which only Na—x zeolite was used and no gold/titanium-oxide catalyst was used was performed according to the following procedure because zeolite such as Na—x zeolite is known to have the ability to adsorb carbon monoxoide. 500 mg of Na—X zeolite sieved to a particle size of 12 to 30 mesh was placed in the catalyst reaction tube. In the same manner as in Example 8, the powdered Na—X zeolite was preheated, and the reaction tube was then placed in the device of FIG. 1. The catalyst-life test was performed under the same conditions as in Example 8. The reaction results are shown in FIG. 5. A slight concentration reduction due to the adsorption of carbon monoxide was observed within 1 minute after the test was started. Compared with Example 8, carbon monoxide was hardly removed by using only Na—X zeolite under the conditions of this Comparative Example.

1. A method for removing carbon monoxide from a gas to be treated, comprising treating the gas with a carbon dioxide and water remover and a gold nanoparticle catalyst in which gold particles having an average particle diameter of 25 nm or less has been supported on a metal oxide.

2. A method for removing carbon monoxide according to claim 1, comprising bringing the gas into contact with the carbon dioxide and water remover and then bringing the treated gas into contact with the gold nanoparticle catalyst.

3. A method for removing carbon monoxide according to claim 1, comprising binging the gas into contact with a mixture of the gold nanoparticle catalyst and the carbon dioxide and water remover.

4. A method for removing carbon monoxide according to any one of claims 1 to 3, wherein the carbon dioxide and water remover is zeolite having a pore size of 0.4 nm or more.

5. A method for removing carbon monoxide according to any one of claims 1 to 4, wherein the temperature of the gold nanoparticle catalyst ranges about room temperature to about 100° C.

6. A method for removing carbon monoxide according to claim 5, further comprising irradiating the gold nanoparticle catalyst with light.

7. A catalyst for removing carbon monoxide comprising a carbon dioxide and water remover and a gold nanoparticle catalyst in which gold particles having an average particle diameter of 25 nm or less are supported on a metal oxide.

8. A catalyst for removing carbon monoxide according to claim 7, wherein the carbon dioxide and water remover is zeolite having a pore size of 0.4 nm or more.

9. A filter comprising the catalyst for removing carbon monoxide according to claim 7 or 8.

10. A filter according to claim 9, having any one of a granule form, a honeycomb form, a bead form, or a fiber form.

11. An air cleaner, comprising a filter according to claim 10.

12. A gas mask for carbon monoxide, comprising a filter according to claim 10.
